(19) United States
(12) Patent Application Publication
(10) Pub. No.: US 2006/0191107 A1
(43) Pub. Date: Aug. 31, 2006

(54) Knob assembly

(76) Inventor: Vincent H. Rose, Powell, WY (US)

Correspondence Address: HENSLEY KIM & EDGINGTON, LLC, 1660 LINCOLN STREET, SUITE 3050, DENVER, CO, 80264, US

(21) Appl. No.: 11/413,403

(22) Filed: Apr. 28, 2006

Related U.S. Application Data
(63) Continuation-in-part of application No. 10/686,819, filed on Oct. 15, 2003, now Pat. No. 7,038,864.
Application No. 10/686,819 is a division of application No. 09/912,196, filed on Jul. 23, 2001, now Pat. No. 6,710,718.
(60) Provisional application No. 60/220,456, filed on Jul. 24, 2000.

(51) Int. Cl. A47J 45/07

(52) U.S. Cl. 16/433

(57) ABSTRACT

A knob assembly includes a knob and a shaft. The knob defines a cavity formed by an interior wall, wherein at least the interior wall of the knob is formed of an elastomeric material. When the knob is pushed on the first end of the shaft, the cavity in the knob receives the first end of the shaft and the elastomeric material frictionally retains the first end of the shaft within the cavity. The shaft may have an interface structure(s) formed about the first end, or may have a keyway sized for mating with a key in the cavity of the knob. The knob may also be covered by a cap.

### CROSS-REFERENCE TO RELATED APPLICATIONS

This application is a continuation-in-part of U.S. application Ser. No. 10,686,819, which is a divisional of U.S. Pat. No. 6,710,718 entitled “Slim Profile Indicating Instruments”, filed 23 Jul. 2001, which claimed the benefit of U.S. provisional application No. 60/220,456 entitled “Slim Profile Tachometer,” filed on 24 Jul. 2000. Each of the applications referenced above is hereby incorporated by reference as though fully set forth herein.

### BACKGROUND OF THE INVENTION

Knobs and knob assemblies are used for numerous applications across a variety of industries and within innumerable types of machines, systems, devices, and vehicles. Knobs are commonly found on indicating instruments, such as those used to measure the speed of a vehicle, such as an automobile or airplane, or measure the rotational speed of an engine shaft or turbine to indicate a need to switch to an appropriate gear ratio so that the motor is not overworked. Knobs are a convenient way for a user to manually reset, control, or monitor settings on indicating instruments, such as fuel, pressure, and temperature gauges, for example. Knobs are also used on devices such as appliances, timers, and dimmer switches for lights.

Knob assemblies may be operably coupled to a variety of different types of instruments or devices and provide a convenient mechanism, or handle, for a user to grasp when manually adjusting an instrument or device. Commonly available knob assemblies utilize plastic knobs for coupling to shafts of instruments or devices. These plastic knobs may be frictionally fitted with, or pressed onto, shafts of the instruments or devices. These plastic knobs may initially have good frictional engagement with the shaft of an instrument or device; however, over time the plastic loses its shape and falls off, resulting in loss of the knob and inability to operate the instrument or device.

Knob assemblies are also commonly coupled to instruments using adhesives, set screws, clips, and/or special tools for assembly. The use of adhesives can be a messy and time-consuming process which may involve curing ovens and/or special preparation of the materials. Set screws and clips add parts and labor which increases the cost of any project and may also require special tools for assembly. Use of these adhesives, set screws, clips, and/or special tools increases the overall cost of a project. Thus, it would be desirable to have a knob assembly which may be securely coupled to any type of instrument without the use of poorly performing plastic knobs, messy and costly adhesives, set screws, clips, or special tools.

### SUMMARY OF THE INVENTION

In one embodiment, a knob assembly comprises a knob and a shaft. The knob defines a cavity formed by an interior wall, wherein at least the interior wall of the knob is formed of an elastomeric material. The shaft has a first end having an outer diameter which is slightly larger than an inner diameter of the cavity. When the knob is pushed on the first end of the shaft the cavity in the knob receives the first end of the shaft and the elastomeric material frictionally retains the first end of the shaft within the cavity.

In another embodiment, a knob assembly comprises a knob and a shaft. The knob defines a cavity formed by an interior wall of the knob wherein at least the interior wall of the knob is formed of an elastomeric material. The shaft has a first end comprising at least one interface structure formed about the first end of the shaft wherein an outer diameter of the interface structure is slightly larger than an inner diameter of the cavity. When the knob is pushed on the first end of the shaft the cavity receives the first end of the shaft and the at least one interface structure mates with the interior wall of the knob. The elastomeric material inhibits the knob from being pulled off the shaft and prevents the knob from rotating relative to the shaft.

In yet another embodiment, a knob assembly comprises a knob and a shaft. The knob defines a cavity formed by an interior wall of the knob wherein the interior wall further comprises at least one key protruding into the cavity. The shaft has a first end comprising an interface structure slightly larger than an inner diameter of the cavity and at least one keyway formed to accept the key in the cavity. When the key in the cavity and the keyway on the first end of the shaft are aligned the knob is pushed on the first end of the shaft and the at least one interface structure mates with the interior wall of the knob inhibiting the knob from being pulled off the shaft. The at least one key couples with the at least one keyway preventing the knob from rotating relative to the shaft.

In another embodiment a knob structure comprises a cavity defined by an interior wall of the knob structure. At least the interior wall of the knob structure is formed primarily of an elastomeric material. The cavity is sized for mating with an end of a shaft. When the knob structure is pushed onto the end of the shaft, the elastomeric material of the interior wall grips the end of the shaft and inhibits the knob from being pulled off the shaft and prevents the knob structure from rotating relative to the shaft.

Other embodiments are also disclosed.

### BRIEF DESCRIPTION OF THE DRAWINGS

Illustrative embodiments of the invention are illustrated in the drawings in which:

FIG. 1 illustrates an exploded isometric view of a first exemplary embodiment of a knob assembly;

FIG. 2A illustrates an end view in elevation of a first exemplary embodiment of a knob;

FIG. 2B illustrates a cross-sectional view in elevation taken along the line 2B-2B of the knob shown in FIG. 2A;

FIG. 3A illustrates an end view in elevation of a first exemplary embodiment of a first end of a shaft;

FIG. 3B illustrates a side view in elevation of the first end of the shaft shown in FIG. 3A;

FIG. 4A illustrates an end view in elevation of a second exemplary embodiment of a first end of a shaft;

FIG. 4B illustrates a side view in elevation of the first end of the shaft shown in FIG. 4A;

FIG. 5A illustrates an end view in elevation of a third exemplary embodiment of a first end of a shaft;

FIG. 5B illustrates a side view in elevation of the first end of the shaft shown in FIG. 5A;

FIG. 6A illustrates an end view in elevation of a fourth exemplary embodiment of a first end of a shaft;

FIG. 6B illustrates a side view in elevation of the first end of the shaft shown in FIG. 6A;

FIG. 7A illustrates an end view in elevation of a second exemplary embodiment of a knob;

FIG. 7B illustrates a cross-sectional view in elevation taken along the line 7B-7B of the knob shown in FIG. 7A;

FIG. 8A illustrates an end view in elevation of a third exemplary embodiment of a knob;

FIG. 8B illustrates a cross-sectional view in elevation taken along the line 8B-8B of the knob shown in FIG. 8A;

FIG. 9A illustrates an end view in elevation of a fifth exemplary embodiment of the first end of a shaft;

FIG. 9B illustrates a side view in elevation of the first end of the shaft shown in FIG. 9A;

FIG. 10 illustrates an exploded isometric view of a second exemplary embodiment of a knob assembly;

FIG. 11A illustrates an end view in elevation of a fourth exemplary embodiment of a knob;

FIG. 11B illustrates a cross-sectional view in elevation taken along the line 11B-11B of the knob shown in FIG. 11A;

FIG. 12A illustrates an end view in elevation of a sixth exemplary embodiment of a first end of a shaft;

FIG. 12B illustrates a side view in elevation of the first end of the shaft shown in FIG. 12A;

FIG. 13 illustrates an exploded isometric view of a third exemplary embodiment of a knob assembly;

FIG. 14A illustrates an end view in elevation of a first exemplary embodiment of a cap;

FIG. 14B illustrates a cross-sectional view in elevation taken along the line 14B-14B of the cap shown in FIG. 14A;

FIG. 15A illustrates an end view in elevation of a second exemplary embodiment of a cap;

FIG. 15B illustrates a cross-sectional view in elevation taken along the line 15B-15B of the cap shown in FIG. 15A;

FIG. 16 illustrates an isometric view of a first exemplary application for a knob assembly;

FIG. 17A illustrates an exploded isometric view of a second exemplary application for a knob assembly; and

FIG. 17B illustrates an assembled isometric view of the application for knob assembly shown in FIG. 17A.

### DETAILED DESCRIPTION

The knob assembly 100, shown in an exploded view in FIG. 1, may be assembled simply by press fitting or friction fitting the knob 102, the shaft 104, and the cap 106 together without the use of messy adhesives, curing ovens, set screws, poorly performing plastics, clips, or other special tools or additional parts. As will be discussed in more detail below, the material used to construct the knob 102, enhances coupling between the knob 102 and the shaft 104 without undesirable slippage, rotation, or uncoupling of the components 102,104 relative to one another.

One implementation of a knob assembly 100 may comprise the knob 102, the shaft 104, and the cap 106. The knob 102, the shaft 104, and the cap 106 may all have corresponding sizes and shapes such that they may be friction fit or press fit together by a user. The shapes and sizes of the knob 102, the shaft 104, and the cap 106 may vary depending upon the final intend use or application for the knob 102. One exemplary embodiment of a knob assembly 100, shown in FIG. 1, illustrates a generally cylindrical knob 102, a shaft 104, and a cap 106, however these components may be formed in any number of shapes and sizes provided the portions to be coupled together are shaped and sized appropriately to be coupled together.

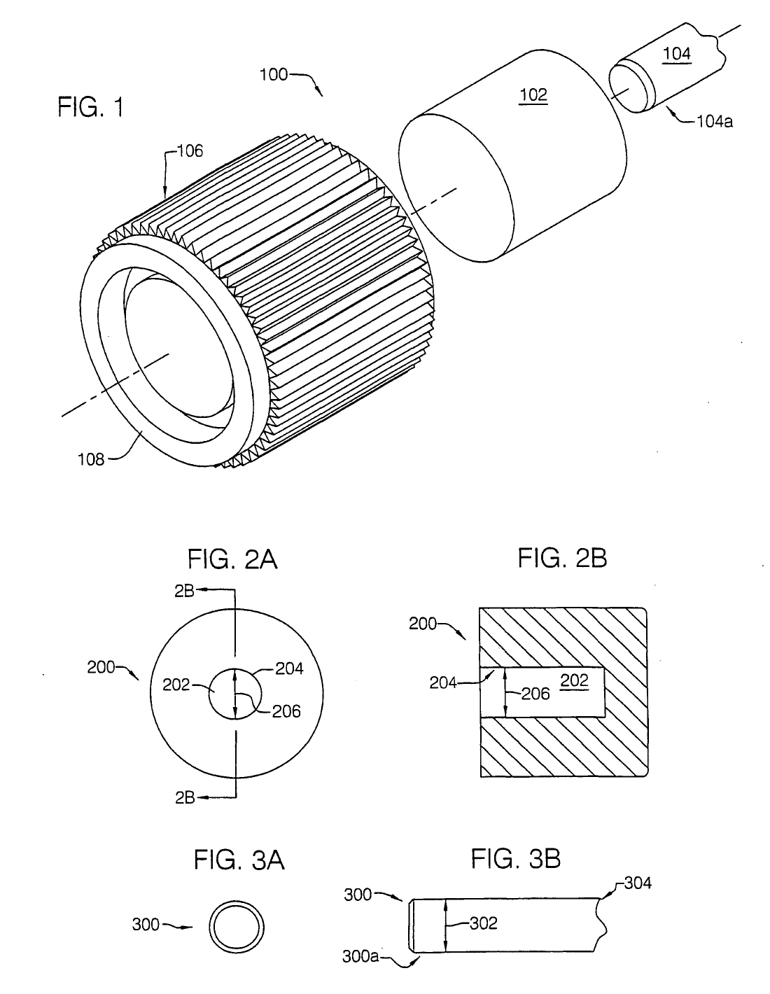

With reference now to FIGS. 1, 2A and 2B, the knob 200 may comprise a structure which defines a cavity 202 formed by an interior wall 204 of knob 200. The shaft 104 may have a first end 104a having an outer diameter which is slightly larger than an inner diameter of the cavity 202 in the knob 200. The cavity 202 in the knob 200 receives the first end 104a of the shaft 104 when the knob 200 is pushed onto the first end 104a of the shaft. The mating between the knob 102, shaft 104, and cap 106 is such that they may not be easily pulled apart, may not be over rotated, and is such that they do not rotate or slip relative to one another.

In one embodiment, at least the interior wall 204 of the knob 200 may comprise an elastomeric material. In other embodiments the entire knob 200, or only a portion of the knob 200, may be formed of the elastomeric material. In some embodiments, only the interior wall 204 of the knob 200 may be formed of the elastomeric material. In these embodiments the elastomeric material may be applied to the interior wall 204 after forming the cavity 202.

The elastomeric material may be any of thousands of different types of moldable rubber and, in some embodiments, may comprise a thermosetting elastomer or a thermoplastic elastomer. The durometer range for elastomeric materials suitable for use herein may be between 40D-80D. It is also anticipated herein that the term ‘elastomeric material’ as used herein may include natural rubbers. The knob 200 and/or the interior wall 204 of the knob may be formed of the elastomeric material using any of a variety of molding methods, such as compression molding and injection molding, for example. Thermosetting elastomers suitable for use herein include, for example, butadiene acronytrile (such as Buna-N® Rubber) or polychloroprene (such as Neoprene® Rubber). Parts from either material are readily available from Minor Rubber Co., Inc. of Broomfield, N.J. in black and beige colors. Thermoplastic elastomers suitable for use herein include, for example, Santoprene® Rubber, available from Advanced Elastomers of Akron, Ohio, or Kraton® Rubber (such as the D&G Series), available from Kraton Polymers of Houston, Tex., in any of a wide variety of colors.

The knob 200 is shown in FIG. 2A as generally cylindrical, but may have any number of exterior shapes, including, but not limited to any combination of ornamental shapes and sizes. The knob 200 may have an exterior shape and design suitable for being easily grasped by an operator of the knob 200, for operation of the knob 200. Alternatively, the knob 200 may be sized for coupling to a cap 106 (shown in FIG. 1), which will be described in more detail below.

As shown in FIG. 2A, cavity 202 in the knob 200 may be generally cylindrical, for example, but may also comprise a number of other shapes. The cavity 202 may have a size and shape corresponding to the size and shape of shaft 104, so that they may be coupled together. Specifically, the cavity 202 may have an inner diameter 206 which is slightly smaller than an outer diameter of shaft 104, so that the cavity 202 may receive the shaft 104 therein.

The shaft 300, shown in FIG. 3, may be a rigid structure having a first end 300a, suitable for mating with the cavity 202 of the knob 200. The shaft 300, may be formed from any number of materials, including rigid plastics or metallic materials, for example. As shown in FIG. 3, the shaft 300 may comprise a generally cylindrical shape, but may also be formed in any number of shapes and sizes suitable for mating with the cavity 202 of the knob 200. The shaft 300 may have any length and a second end 304 of the shaft 300 may be operably coupled to an instrument or device (not shown in FIG. 3) for manual adjustment of an instrument or device by a user.

The first end 300a of the shaft 300 may have an outer diameter 302 slightly larger than the inner diameter of the cavity 206. When the knob 200 is pushed onto the first end 300a of the shaft 300 the cavity 202 receives the first end 300a of the shaft 300 and the elastomeric material forming the interior wall 204 of the cavity 202 frictionally retains the first end of the shaft within the cavity 202 of the knob 200. In the embodiment shown in FIGS. 1-3, the elastomeric material provides enhanced coupling between the knob 202 and the shaft 300 which prevents the knob 202 from being easily pulled off of shaft 300 and also prevents the knob 202 from rotating with respect to the shaft 300.

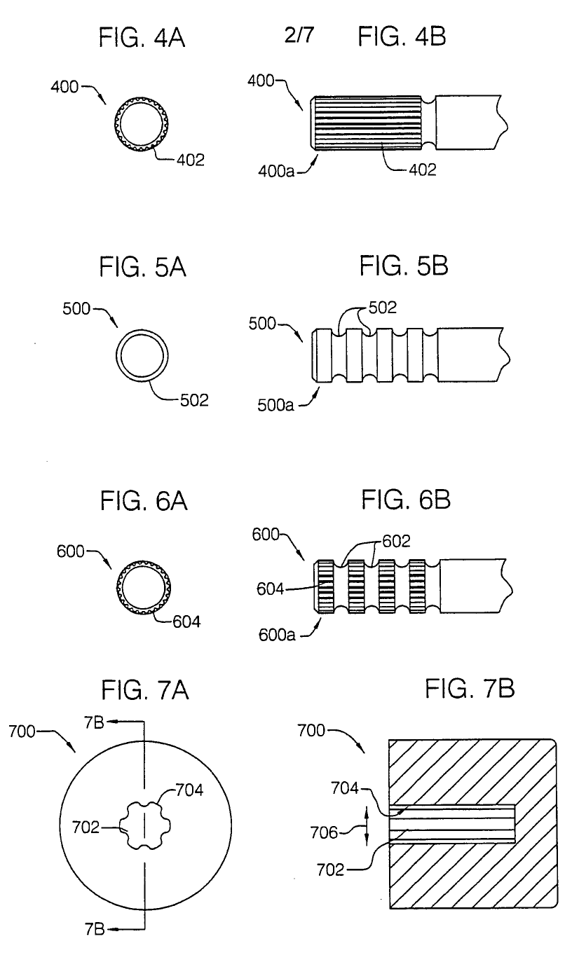

Alternatively, the first end 300a of shaft 300 may comprise a number of interface structures formed about the first end 300a of the shaft 300 to enhance the frictional engagement between the knob 200 and shaft 300. As shown in FIG. 4B, the shaft 400 may have a first end 400a having knurls 402 as an interface structure. The knurls 402 provide enhanced frictional engagement between the first end 400a of the shaft 400 and the interior wall 204 of the cavity 202 of the knob 200. Knurls 402 may be formed in any number of different patterns and, in one example, is shown longitudinally knurled in FIG. 4B. In other embodiments, knurls may be formed in a diamond pattern or a cross-hatched pattern, for example.

As shown in FIG. 5B, the shaft 500 may have a first end 500a having concentric grooves 502 as an interface structure. The concentric grooves 502 may prevent over rotation of the knob by a user as well as providing the enhanced frictional engagement between the first end 500a of the shaft 500 and the interior wall 204 of the cavity 202 of the knob 200. In another embodiment, shown in FIG. 6B the concentric grooves 602 may further comprise knurls 604 to further enhance frictional engagement. In an alternative embodiment, shown in FIG. 7A, the cavity 702 of the knob 700 may be shaped to provide additional enhanced frictional engagement. As shown in FIG. 7A, the cavity 702 of the knob 700 may have a grooved interior wall 704.

It is important to note than any of the knobs and shafts described herein may be used interchangeably with any other knobs and shafts described herein. Said another way, the knobs and shafts of the various embodiments described herein are interchangeable.

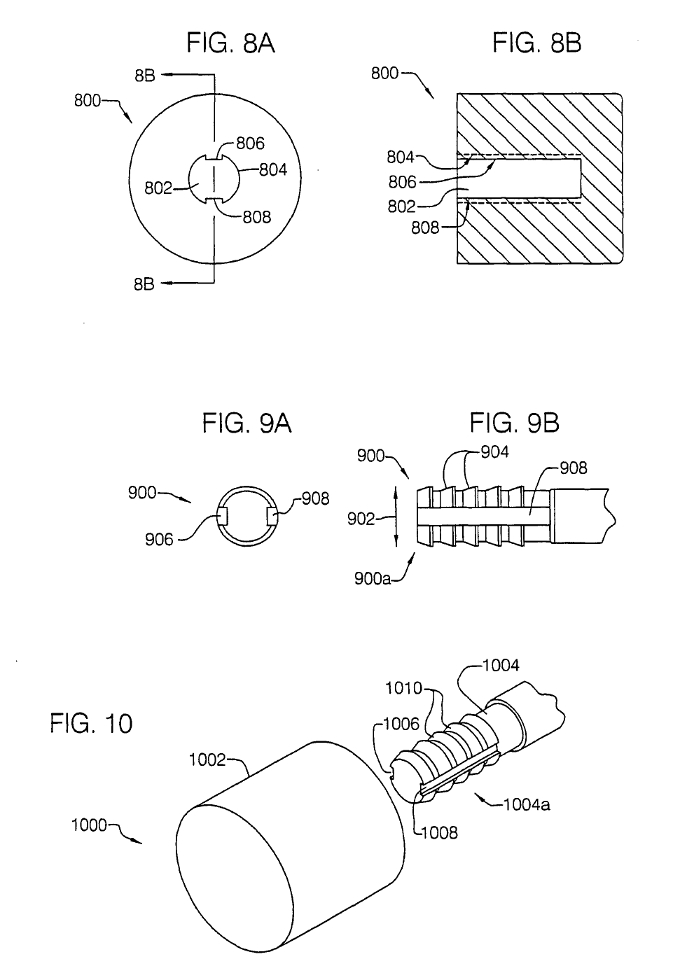

In another embodiment, shown in FIGS. 8A and 8B, the knob 800 may be formed of the elastomeric material with keys 806, 808 axially molded into the interior wall 804 such that the keys 806, 808 protrude into the cavity 802. As shown in FIGS. 9A and 9B, the shaft 900 may have a first end 900a having an interface structure formed about the first end 900a and may have keyways 906 and 908 axially molded into the walls of the shaft 900 and sized to mate with keys 806 and 808. The mating of the keys 806, 808 in the knob 800 with the keyways 906, 908 in the shaft 900 enhances frictional engagement between the knob 800 and the shaft 900 and prevents the knob 800 from rotating relative to the shaft 900. In an alternative embodiment, keyways may be formed into the walls of the cavity 802 of the knob 800 and keys may be formed on the shaft 900. Shaft 900 may further comprise barbs 904 for to further grip the interior wall 804 of the knob 800 and further prevent the knob 800 from being pulled off the shaft 900. FIG. 10 illustrates an isometric view of the coupling of the knob 800 and the shaft 900 as described with regard to FIGS. 8A, 8B, 9A, and 9B.

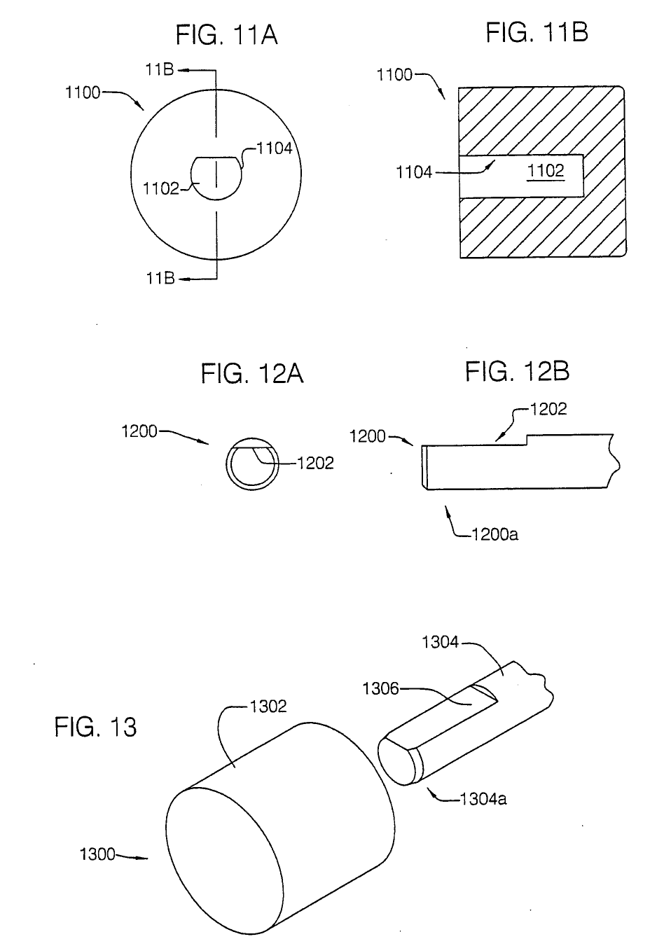

In yet another embodiment shown in FIGS. 11A and 11B, the knob 1100 may be formed of the elastomeric material and may have a cavity 1102 having an approximately D-shaped cross-section 1104. As shown in FIGS. 12A and 12B, the shaft 1200 may have a first end 1200a having an approximately D-shaped cross section 1202 formed about the first end 1200a of the shaft 1200 and sized to make with the D-shaped cavity 1102 of the knob 1100. The mating of the D-shaped cavity 1102 and the D-shaped shaft 1200 enhances frictional engagement between the knob 1100 and the shaft 1200 and prevents the knob 1100 from rotating relative to the shaft 1200. FIG. 13 illustrates an isometric view of the coupling of knob 1302 and shaft 1304, having a flat portion or D-shaped cross-section 1306, as described with regard to FIGS. 11A, 11B, 12A, and 12B. In alternative embodiments the shaft 1304 may have flattened portions (similar to 1306) on more than one side, which would correspond to flattened portions in a cavity of the knob.

As mentioned above and shown in FIG. 1, the knob assembly 100 may further comprise a cap 106. One embodiment of a cap 1400 is shown in more detail in FIGS. 14A and 14B. The cap 1400 may define a cap cavity 1402 formed by an interior wall 1404 of the cap 1400. The cap cavity 1402 may have an inner diameter 1406, which is slightly smaller than an outer diameter of the knob 1408. In some embodiments, the knob 1408 may be pushed into the cap 1400, and in other embodiments the knob 1408 may be insert molded into the cap 1400. When the cap 1400 and the knob 1408 are coupled together, the interior wall 1404 of the cap 1400 mates with an elastomeric outer diameter of the knob 1408 and prevents the cap 1400 from being easily pulled off of the knob 1408. The elastomeric material of the knob 1408 also enhances frictional engagement between the knob 1408 and the cap 1400, preventing the knob 1408 from rotating relative to the cap 1400.

The cap 1400 shown FIGS. 14A and 14B may also comprise a cosmetic disk or ring (not shown) to enhance the physical appearance of the cap 1400. The cap 1400 may be formed for example, of anodized metal, hard plastic, or polished aluminum. The cap 1400 may also comprise ridges or knurls 1410 on its outer surface to enhance the physical appearance of the cap 1400. The knurls 1410 may also make it easier for a user or operator of the cap 1400 to manually twist the cap 1400.

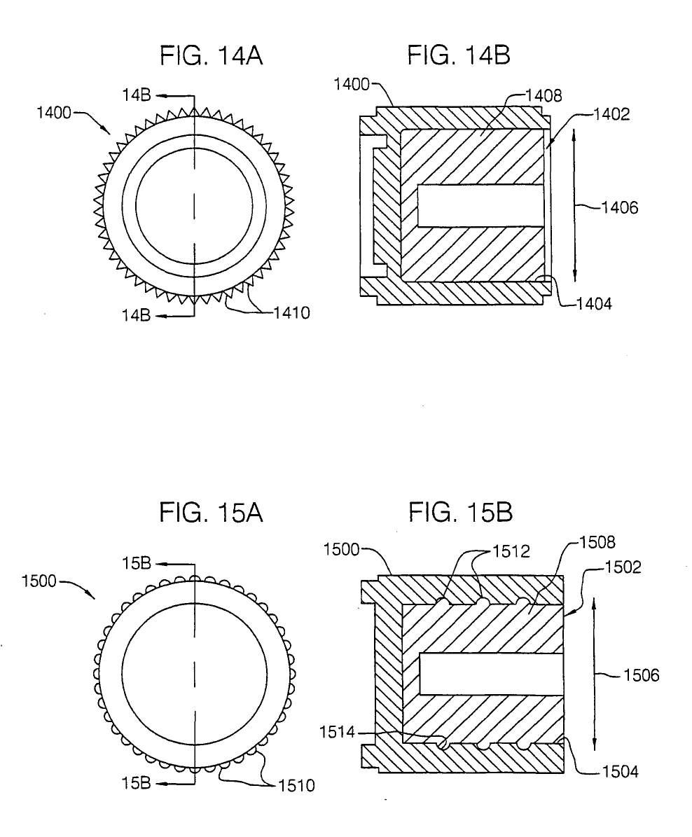

With reference now to FIGS. 15A and 15B, a second embodiment of a cap 1500 is shown. The coupling of the cap 1500 and knob 1508 may further be enhanced by the addition of concentric grooves 1514 to the interior wall 1504 of the cap 1500. The knob 1508 may have concentric ridges 1512 corresponding in size, shape, and number to the concentric groves 1514 on the cap 1500. When the knob 1508 is coupled to the cap 1500 the concentric ridges 1512 on the knob 1508 mate with the concentric grooves 1514 in the cap 1500 to provide enhanced frictional engagement and help to prevent the cap 1500 from being easily pulled off of the knob 1508. As shown, the outer surface of the cap 1500 is may comprise ridges or knurls 1510, which may be cosmetic and/or may provide a user with enhanced grip during operation.

It should be understood that any combination of the multiple embodiments listed herein may be used in conjunction with the elastomeric materials disclosed herein to provide the enhanced frictional engagement between the knob 102 and the shaft 104. Additionally, it is to be understood that while the knob assembly 100 may be supplied in its entirety, it is also possible to supply only the knob 102 of the materials and/or shapes disclosed herein in order to accomplish the teachings herein. For example, a knob 102 of the elastomeric materials and shape disclosed herein may be applied to any shaft on any pre-existing device or instrumentation.

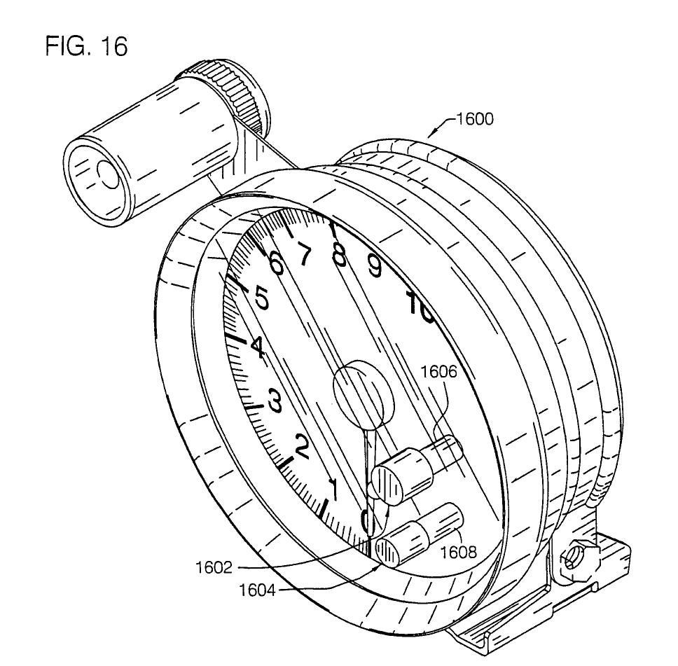

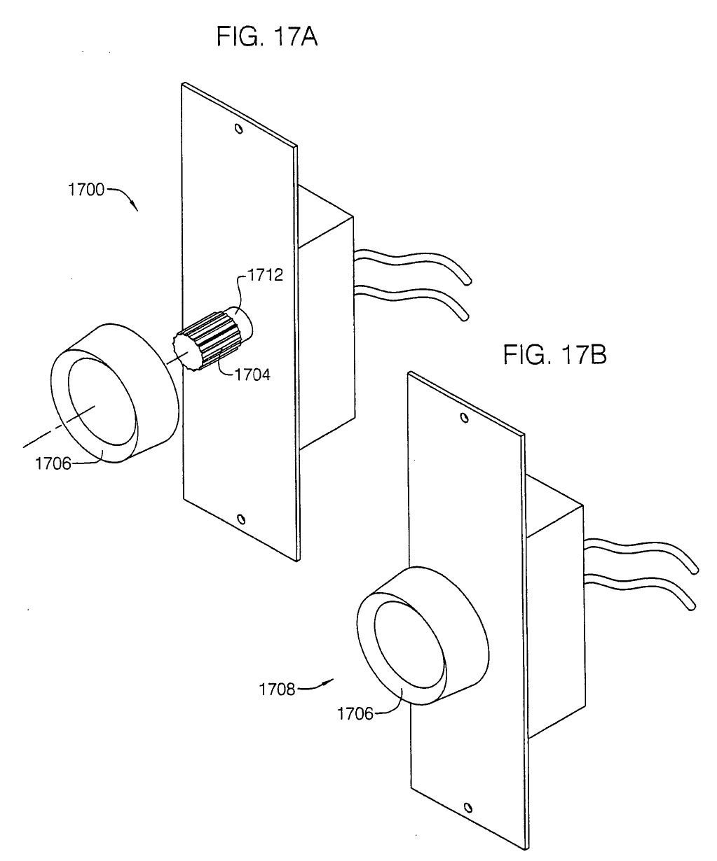

Implementation of an exemplary knob assembly is illustrated in FIG. 16. As shown in FIG. 16 knobs 1602, 1604 produced in accordance with the teachings herein may be applied to shafts 1604, 1606 of a tachometer 1600, for example. As shown in FIG. 16, the knobs 1602 and 1604 may have different sizes. The knobs 1602, 1604 may be easily grasped by an operator of an automobile for manual adjustment of the tachometer 1600, for example. As shown in FIG. 1 7A, a knob 1706 produced in accordance with the teachings herein may also be implemented on a dimmer switch 1700. The knob 1706 may be pushed onto shaft 1702, which has knurls 1704, as described herein. FIG. 17B illustrates an assembled view of a dimmer switch 1708 utilizing a knob 1706 and a shaft 1704 produced in accordance with the teachings herein. Note that the knob 1706 shown in FIGS. 1 7A and 1 7B is molded into an ornamental shape.

It should be understood that various changes and modifications to the presently preferred embodiments described herein will be apparent to those skilled in the art. It is foreseeable that the shape and size of the knobs, shafts, and caps may be varied. It is also foreseeable that the knobs, shafts, and caps may be manufactured out of a plurality of different materials, including different moldable elastomeric materials. The examples given herein are not meant to be limiting, but rather are exemplary of the modifications that can be made without departing from the spirit and scope of the present invention and without diminishing its attendant advantages.

What is claimed is:

1. A knob assembly comprising:
a knob defining a cavity formed by an interior wall of the knob;
wherein at least the interior wall of the knob is formed of an elastomeric material;
a shaft having a first end;
wherein an outer diameter of the first end of the shaft is slightly larger than an inner diameter of the cavity; and
wherein when the knob is pushed on the first end of the shaft, the cavity in the knob receives the first end of the shaft; and
the elastomeric material frictionally retains the first end of the shaft within the cavity.

2. The knob assembly of claim 1, wherein the elastomeric material comprises at least one of a thermosetting elastomer or a thermoplastic elastomer.

3. The knob assembly of claim 1, wherein the knob is formed primarily of the elastomeric material.

4. The knob assembly of claim 1, further comprising a cap;
the cap defining a cap cavity formed by an interior wall of the cap;
wherein the interior wall of the cap mates with an elastomeric surface of the first end of the knob, and thereby inhibits the cap from being pulled off the knob and prevents the cap from rotating relative to the knob.

5. A knob assembly comprising:
a knob defining a cavity formed by an interior wall of the knob,
wherein at least the interior wall of the knob is formed of an elastomeric material;
a shaft with a first end, the first end of the shaft further comprising
at least one interface structure formed about the first end of the shaft; and
wherein an outer diameter of the interface structure is slightly larger than an inner diameter of the cavity;
wherein when the knob is pushed on the first end of the shaft,
the cavity receives the first end of the shaft;
the at least one interface structure mates with the interior wall of the knob; and
the elastomeric material inhibits the knob from being pulled off the shaft and prevents the knob from rotating relative to the shaft.

6. The knob assembly of claim 5, wherein the at least one interface structure formed about the first end of the shaft is knurled.

7. The knob assembly of claim 5, wherein the at least one interface structure formed about the first end of the shaft is concentrically grooved.

8. The knob assembly of claim 5, wherein the at least one interface structure formed about the first end of the shaft comprises at least one concentric barb.

9. The knob assembly of claim 5, wherein the cavity in the knob has a generally D-shaped cross-section and the at least one interface structure formed about the first end of the shaft has a generally D-shaped cross-section.

10. The knob assembly of claim 5, wherein the cavity in the knob has a grooved interior wall.

11. The knob assembly of claim 5, wherein the elastomeric material comprises at least one of a thermosetting elastomer or a thermoplastic elastomer.

12. The knob assembly of claim 5, wherein the knob is formed primarily of the elastomeric material.

13. The knob assembly of claim 5, further comprising a cap;
the cap defining a cap cavity formed by an interior wall of the cap;
wherein the interior wall of the cap mates with an elastomeric surface of the first end of the knob, and
thereby inhibits the cap from being pulled off the knob and prevents the cap from rotating relative to the knob.

14. The knob assembly of claim 13, wherein the knob further comprises at least one ridge protruding from its outer diameter and wherein the cap further comprises at least one groove formed to accept the at least one ridge on the knob.

15. A knob assembly comprising:
a knob defining a cavity formed by an interior wall of the knob;
the interior wall further comprising at least one key protruding into the cavity;
a shaft having a first end, the first end of the shaft further comprising
at least one interface structure formed about the first end of the shaft, wherein an outer diameter of the interface structure is slightly larger than an inner diameter of the cavity; and
at least one keyway formed to accept the key in the cavity;
wherein when the key in the cavity and keyway on the first end of the shaft are aligned and
the knob is pushed on the first end of the shaft,
the at least one interface structure mates with the interior wall of the knob inhibiting the knob from being pulled off the shaft; and
the at least one key couples with the at least one keyway preventing the knob from rotating relative to the shaft.

16. The knob assembly of claim 15, wherein the at least one interface structure formed about the first end of the shaft is knurled.

17. The knob assembly of claim 15, wherein the at least one interface structure formed about the first end of the shaft is concentrically grooved.

18. The knob assembly of claim 15, wherein the at least one interface structure formed about the first end of the shaft comprises at least one concentric barb.

19. The knob assembly of claim 15, wherein at least the interior wall of the knob is formed of an elastomeric material which inhibits the knob from being pulled off the shaft and prevents the knob from rotating relative to the shaft.

20. The knob assembly of claim 19, wherein elastomeric material comprises at least one of a thermosetting elastomer or a thermoplastic elastomer.

21. The knob assembly of claim 15, wherein the knob is formed primarily of an elastomeric material.

22. The knob assembly of claim 15, further comprising a cap;
the cap defining a cap cavity formed by an interior wall of the cap;
wherein the interior wall of the cap mates with an elastomeric surface of the first end of the knob, and
thereby inhibits the cap from being pulled off the knob and prevents the cap from rotating relative to the knob.

23. The knob assembly of claim 22, wherein the knob further comprises at least one ridge protruding from its outer diameter and wherein the cap further comprises at least one groove formed to accept the at least one ridge on the knob.

24. A knob comprising:
a knob structure;
a cavity defined by an interior wall of the knob structure;
wherein at least the interior wall of the knob structure is formed primarily of an elastomeric material;
wherein the cavity is sized for mating with an end of a shaft; and
wherein when the knob structure is pushed onto the end of the shaft,
the elastomeric material of the interior wall grips the end of the shaft; and
the elastomeric material of the interior wall inhibits the knob structure from being pulled off the shaft and prevents the knob from rotating relative to the shaft.

25. The knob of claim 24, wherein the cavity in the knob structure has a grooved interior wall.

26. The knob of claim 24, wherein the cavity in the knob structure has a generally D-shaped cross-section sized for mating with a shaft having a generally D-shaped cross-section.
